(19) United States
(12) Patent Application Publication
(10) Pub. No.: US 2012/0039662 A1
(43) Pub. Date: Feb. 16, 2012

(54) STYLUS

(75) Inventors: YONG-GANG ZHANG, Shenzhen (CN); KUAN-HUNG CHEN, Shindian (TW)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/883,285

(22) Filed: Sep. 16, 2010

(30) Foreign Application Priority Data
Aug. 11, 2010 (CN) 201020288621.1

(51) Int. Cl. B43K 29/00; G06F 3/033

(52) U.S. Cl. 401/195; 345/179

(57) ABSTRACT

A stylus includes a housing defining a receptacle therein; a stylus body assembly including a stylus body. The stylus body includes a first end, a stylus head mounted on the first end, a second end opposite to the first end and a pen head mounted on the second end; the first end and the second end are selectively accommodated in the receptacle for using the stylus head or the pen head.

### BACKGROUND

1. Technical Field

This exemplary disclosure generally relates to retractable/extendable styluses.

2. Description of Related Art

It is well-known that a variety of devices include a touch screen. Examples of such devices include smart phones, personal digital assistants (PDA), pagers, and personal organizers. These devices typically include a display module under the touch screen, that generates target images associated with menu options, programs, user choices, and other operations. The user controls the device by pressing the touch screen with a stylus over the target image. However, typical styluses have no other functions then to be used with a touch screen.

Therefore, there is room for improvement within the art

### BRIEF DESCRIPTION OF THE DRAWINGS

Many aspects of the exemplary stylus can be better understood with reference to the following drawings. The components in the various drawings are not necessarily drawn to scale, the emphasis instead being placed upon clearly illustrating the principles of the exemplary stylus. Moreover, in the drawings, like reference numerals designate corresponding parts throughout the diagrams.

FIG. 1 is an exploded view of an exemplary embodiment of a stylus.

FIG. 2 is an assembled view of a stylus body assembly shown in FIG. 1.

FIG. 3 is an assembled view of the stylus shown in FIG. 1.

FIG. 4 is another assembled view of the stylus shown in FIG. 1.

FIG. 5 is a cross-sectional view of the stylus in FIG. 3 along the line V-V.

FIG. 6 is a cross-sectional view of the stylus in FIG. 4 along the line VI-VI.

### DETAILED DESCRIPTION

In this exemplary embodiment, the stylus is used to contact a touch screen display of an electronic device such as a mobile telephone. The mobile telephone described herein is a representation of the type of wireless communication device that may benefit from the exemplary embodiment. However, it is to be understood that the exemplary embodiment may be applied to any type of hand-held or portable device including, but not limited to, the following devices: radiotelephones, cordless phones, paging devices, personal digital assistants, portable computers, pen-based or keyboard-based handheld devices, remote control units, portable media players (such as an MP3 or DVD player) that have wireless communication capability. Accordingly, any reference herein to the mobile telephone should also be considered to apply equally to other portable wireless electronic devices.

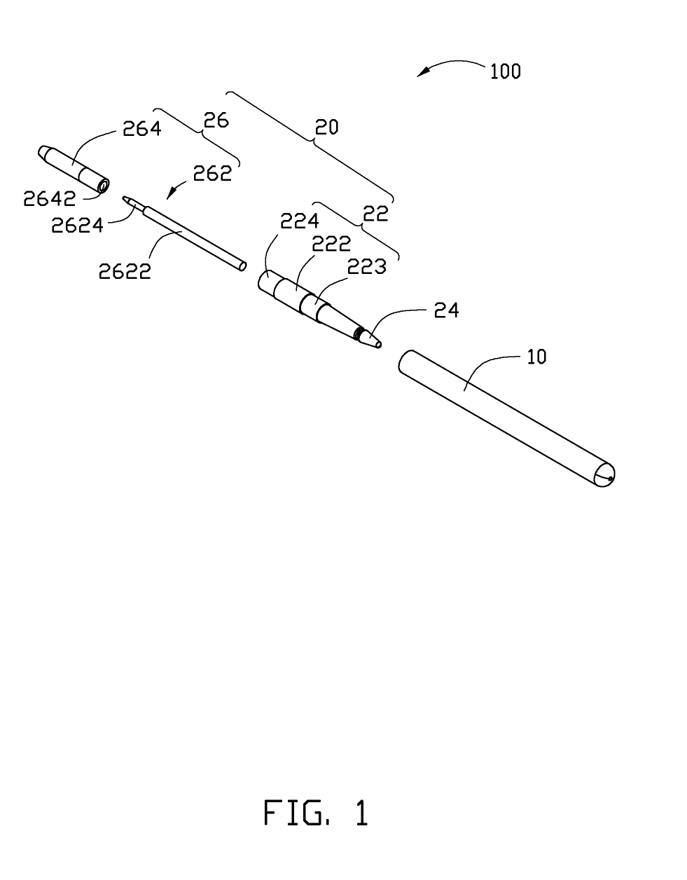

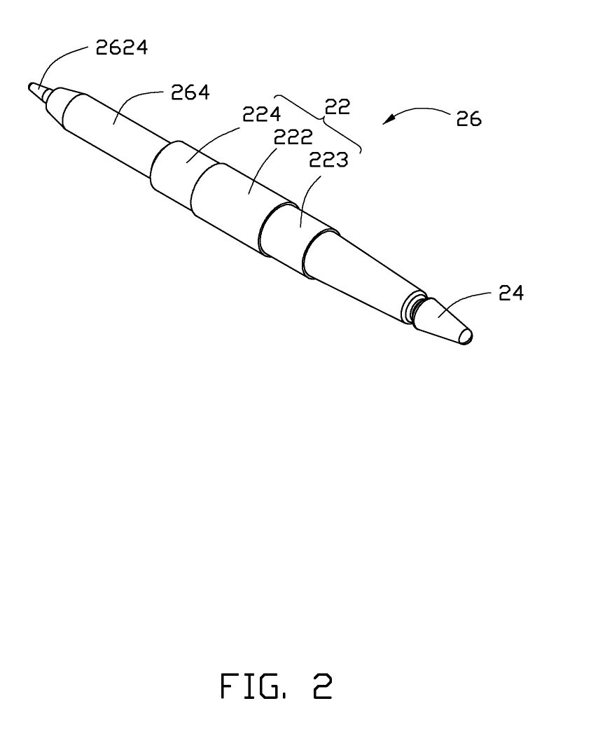

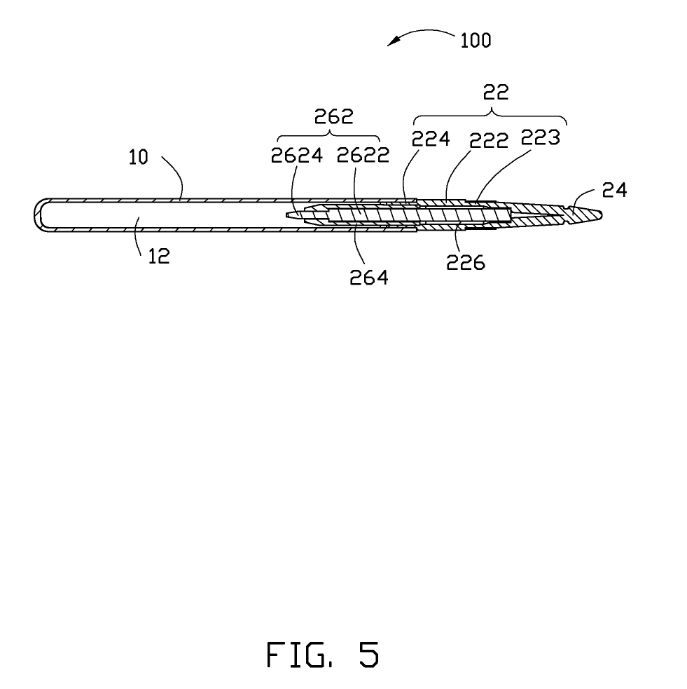

Referring to FIGS. 1 and 2, a stylus 100 includes a housing 10, a stylus body assembly 20. The stylus body assembly 20 includes a stylus body 22, a stylus head 24 located at one end of the stylus body 22 and a pen 26 (e.g., ballpoint pen) located at the other end of the stylus body 22. The housing 10 defines a receptacle 12 (FIG. 5) at one end thereof for selectively accommodating the stylus head 24 and the pen 26.

Referring to FIGS. 1-2, the stylus body 22 includes a grip portion 222, a first retaining portion 223 protruding from one end of the grip portion 222, and a second retaining portion 224 protruding from the other end of the grip portion 222. The stylus body 22 further defines a compartment 226 (FIG. 5) in the second retaining portion 224 and extending into the grip portion 222. The grip portion 222 is for the user to hold the stylus body 22. The first retaining portion 223 and the second retaining portion 224 are for selective accommodation in the receptacle 12 to retain the stylus body assembly 20 in the housing 10. The compartment 226 is for accommodating the pen 26 therein.

Referring to FIGS. 1-2, the stylus head 24 is used to contact a touch screen display (not shown) of an electronic device such as a mobile telephone. The pen 26 may include a pen body 262 including a main body 2622 and a pen head 2624 protruding from one end of the main body 2622, and a shell 264. The main body 2622 is accommodated in the compartment 226 and the pen head 2624 extends out of the compartment 226. The shell 264 covers the stylus body 22 and is retained in the compartment 226 to hold the pen body 262 in the compartment 226. The shell 264 further defines a passage 2642 for the pen head 2624 to pass through the shell 264.

Referring to FIGS. 2-3 and 5, in assembly, the pen body 262 is inserted into the compartment 226 with the pen head 2624 extending out of the compartment 226. The shell 264 covers the pen head 2624 with the pen head 2624 passing through the passage 2642 and the shell 264 so the pen body 262 is retained in the stylus body 22. Finally, either the first retaining portion 223 or the second retaining portion 224, is accommodated in the receptacle 12.

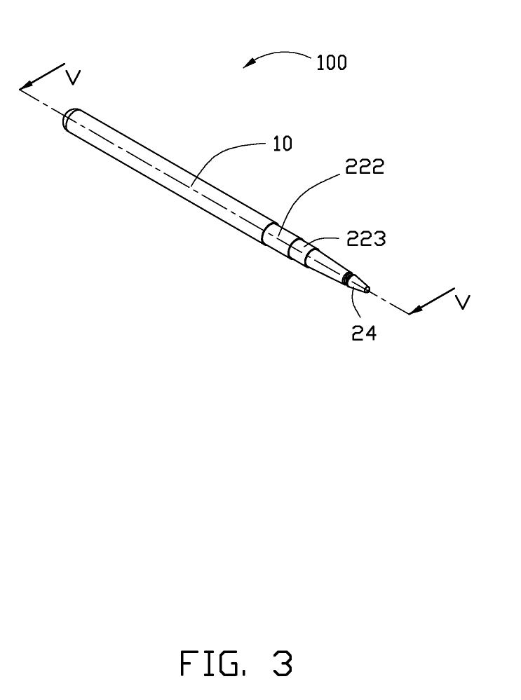

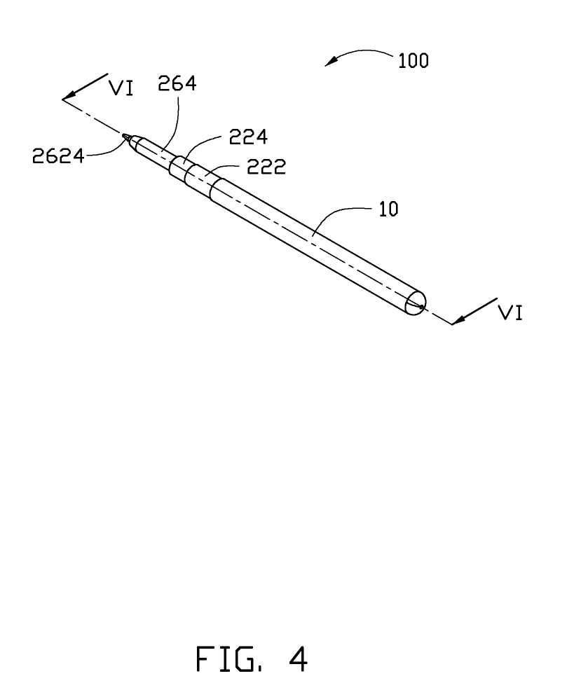

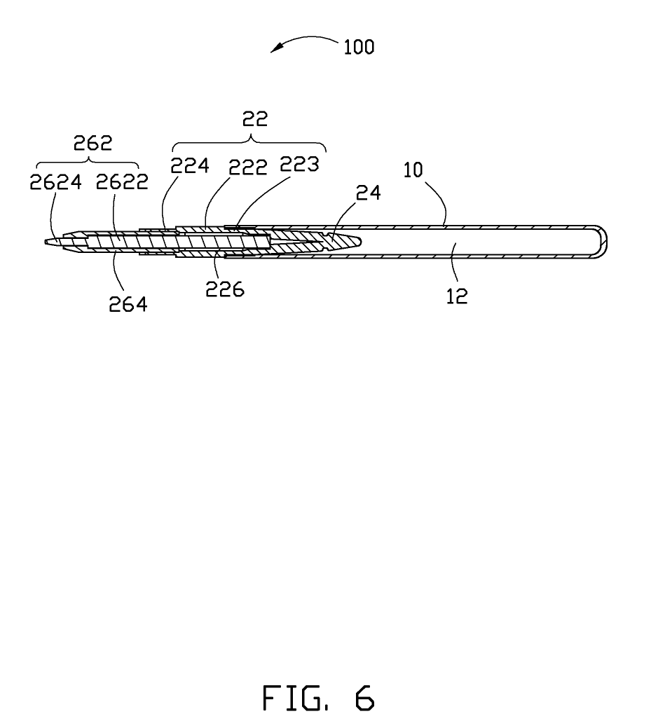

Referring to FIGS. 3 and 5, to use the stylus head 24 to touch a touch screen on an electronic device, the second retaining portion 224 is retained in the receptacle 12 to protect the pen head 2624 and the stylus head 24 is exposed for use. Referring to FIGS. 4 and 6, to use the pen 26 the grip portion 222 is held by the user and then the second retaining portion 224 is pulled until the second retaining portion 224 slides out of the receptacle 12. Then the first retaining portion 223 is retained in the receptacle 12 to protect the stylus head 24 and the pen head 2624 is exposed for use.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A stylus, comprising:
a housing defining a receptacle therein;
a stylus body assembly including a stylus body, wherein the stylus body includes a first end and a second end, a stylus head is mounted on the first end, and a pen head is mounted on the second end; the first end and the second end can be selectively accommodated in the receptacle.

2. The stylus as claimed in claim 1, wherein the stylus body further includes a first retaining portion formed on the first end and a second retaining portion formed on the second end, the first retaining portion and the second retaining portion can be selectively accommodated in the receptacle.

3. The stylus as claimed in claim 2, wherein the stylus body further includes a grip portion located between the first retaining portion and the second retaining portion.

4. The stylus as claimed in claim 3, wherein the stylus further includes a pen including a pen body; the pen body includes a main body and the pen head protruding from the main body.

5. The stylus as claimed in claim 4, wherein the stylus body further defines a compartment in the second retaining portion, the main body is accommodated in the compartment and the pen head extends out of the compartment.

6. The stylus as claimed in claim 5, wherein the pen further includes a shell which covers on the stylus body and is retained in the compartment to hold the pen body in the compartment.

7. A stylus, comprising:
a housing defining a receptacle therein;
a stylus body assembly including a stylus body, wherein the stylus body includes a first end and a second end, a stylus head is mounted on the first end, and a pen head is mounted on the second end; the first end and the second end can be selectively accommodated in the receptacle; when one of the first end and the second end is accommodated in the receptacle, the other end extends out of the receptacle.

8. The stylus as claimed in claim 7, wherein the stylus body further includes a first retaining portion formed on the first end and a second retaining portion formed on the second end, the first retaining portion and the second retaining portion can be selectively accommodated in the receptacle.

9. The stylus as claimed in claim 8, wherein the stylus body further includes a grip portion located between the first retaining portion and the second retaining portion.

10. The stylus as claimed in claim 9, wherein the stylus further includes a pen including a pen body; the pen body includes a main body and a pen head protruding from the main body.

11. The stylus as claimed in claim 10, wherein the stylus body further defines a compartment in the second retaining portion, the main body is accommodated in the compartment and the pen head extends out of the compartment.

12. The stylus as claimed in claim 11, wherein the pen further includes a shell which covers on the stylus body and is retained in the compartment to hold the pen body in the compartment.
